(19) United States
(12) Patent Application Publication
(10) Pub. No.: US 2008/0020782 A1
(43) Pub. Date: Jan. 24, 2008

(54) SYSTEM AND METHOD FOR LOCATING MISPLACED ITEMS

(76) Inventor: Nassim Nasser, Carlsbad, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/458,979

(22) Filed: Jul. 20, 2006

(51) Int. Cl. H04Q 7/20

(52) U.S. Cl. 455/456.1

(57) ABSTRACT

The system for finding lost articles such as keys includes a receiving unit that is physically attached to the article and programmed to activate upon receipt of a unique code transmitted via a wireless communications network. A mobile phone has a pre-programmed function code that, upon pressing a specific set of keys causes the wireless network to automatically transmit the unique code. When activated, the receiving unit emits an audible signal and simultaneously, or after a programmed delay, activates a digital display with the owner's contact information.

### FIELD OF THE INVENTION

The present invention relates to a system and method for locating a lost item, such has a set of keys, from a variable distance using a wireless communication system.

### BACKGROUND OF THE INVENTION

Many systems have been proposed and numerous systems are available on the market for locating lost articles. Some of these systems include the use of a transmitter that sends out an encoded electromagnetic signal, such as a radio frequency (RF) signal, and a receiver that is attached to the lost article. The receiver only responds to the unique encoded RF signal and emits an audible sound when it receives the proper signal. Some of these RF devices are used for locating multiple items and have several buttons on the transmitter, with each button relating to a specific item. Such systems are limited to usage for finding items misplaced within a home or other limited area due to the relatively short range. Other receivers reply with a signal similar to a transponder, allowing a transmitter/receiver to pick up the signal and display the distance and direction to the lost article. Some systems utilize GPS (global positioning system) tracking devices to help locate the article when the device is activated. These systems work only if the receiver is within range of the transmitter.

Another system involves the user making a noise, such as clapping their hands, which in turn causes a device attached to the lost article to emit an audible signal, thus allowing the article to be found, but only if within hearing range. One problem with this type of system is that the activation range of the device is limited to sensitivity of the detector and the ability of the detector to distinguish between a person clapping to activate the system and other sounds that could activate the system. Such systems are appropriate for a room or small number of rooms, but would not allow for the location of a lost item that had been inadvertently left at a more distant location, such as on a store counter or in a restaurant.

The Benvenuti patent, U.S. Pat. No. 6,166,652, incorporated herein by reference, describes a system in which a user calls a paging service, keys in a specific code, and the paging service transmits a signal to a receiver attached to an article. The receiver emits an audible signal, allowing the person to find the misplaced article by hearing the sounded generated by the receiver. The Benvenuti device only works if the user is within hearing range of the receiver, the person must subscribe to a paging service, have access to that service, and be able to remember the specific code that will activate the appropriate signal.

Another patent document, Pat. Pub. No. 2005/0062613 (Sandberg), incorporated herein by reference, describes a system with a transmitter and a receiver for locating misplaced items. The transmitter uses a Bluetooth®-module to transmit a Bluetooth® standard RF signal and may be integrated into a mobile phone. An item is located by pressing a button on the key pad which causes the Bluetooth®-module to transmit a locating signal. The receiver may produce a sound or vibrate to assist in the item's discovery. A drawback of this system is that the user must have a Bluetooth®-capable phone and the item to be found must be within range of the Bluetooth® RF signal, plus the user needs to be within hearing range of the receiver.

Accordingly, in view of the limitations and shortcomings of the existing systems, the need remains for a relatively inexpensive and easily implemented system for locating misplaced items at varying distances.

### BRIEF SUMMARY OF THE INVENTION

In an exemplary embodiment, the system for finding lost articles such as keys includes a receiving unit that is physically attached to the article and programmed to activate upon receipt of a unique code transmitted via a wireless communications network. A mobile phone has a pre-programmed function code that, upon pressing a specific set of keys causes the wireless network to automatically transmit the unique code. When activated, the receiving unit emits an audible signal and simultaneously, or after a programmed delay, activates a digital display with the owner's contact information.

The present invention comprises a cell phone, a cell phone system, and a receiver that are used to find a lost item to which the receiver is attached. A standard, off-the-shelf mobile (cell) phone is encoded with a specialized pre-programmed function or “vertical service code”. When a specific key stroke, such as pressing the “*” (star) key followed by pressing the number “5” key, or, on a pressing the star key followed by pressing the “k” key on a PDA (personal digital assistant) or smart phone, the pre-programmed function in the cell phone is activated. Alternatively, the user can spell out the word “key” or “keys” by entering three or four characters after the star key. On most phones, the number “5” key is the same key as the “k” key. The activated pre-programmed function causes the cell phone to emit a coded signal that is picked up by a nearby cell transceiver station. The cell phone system then transmits an encoded wireless signal over the cell network that is encoded for a specific receiver.

The receiving unit is activated by the signal and emits an audible signal, such as a high pitched beep, allowing a user to locate the lost keys (or other item) if he or she is within an audible range. The receiving unit, which is approximately the size of contemporary automobile alarm remotes, has an attached key chain to allow the keys to be physically attached to the key ring.

The receiving unit also includes a digital, e.g., LCD, display which facilitates recovery of the lost item when the owner of the keys is not able to hear the beeping sound, either due to background noise or distance, and/or the lost keys have been found by someone else. The digital display produces a read out with the cell phone number, and possibly the name, of the user who has activated the device to allow the finder of the keys to call the number and tell the owner where the keys are and how to recover them. The phone number may also be any phone number, chosen by the owner, that is to be called if the lost keys are found by someone other than the owner. In one embodiment, the receiver includes caller ID capability, so that the receiver automatically displays that caller's telephone number.

### BRIEF DESCRIPTION OF THE DRAWINGS

Understanding of the present invention will be facilitated by consideration of the following detailed description of a preferred embodiment of the present invention taken in conjunction with the accompanying drawings, in which like numerals refer to like parts.

FIG. 1 is a diagrammatic front view of a exemplary receiving unit of the present invention.

FIG. 2 is a diagrammatic back view of the receiving unit.

FIG. 3 is a diagrammatic illustration of the receiving unit being activated.

### DETAILED DESCRIPTION OF THE PREFERRED EMBODIMENTS

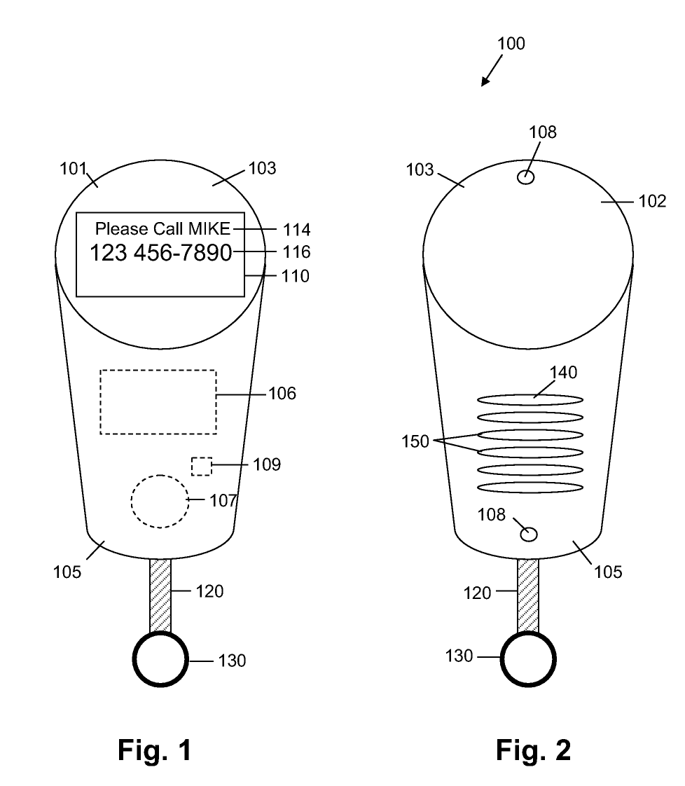

Referring to FIGS. 1 and 2, the receiving unit 100 is a device for receiving a signal from a cell phone system and is approximately the size of a contemporary automobile alarm push button device and fits easily into a pocket. The receiving unit 100 has a generally hollow housing with a top end 103, a bottom end 105, a front side 101, illustrated in FIG. 1, a back side 102, illustrated in FIG. 2, one or more screws 108, or other fasteners, to hold the back side 102 to the front side 101, a digital display 100, a sound generator 140, electronic circuitry 106, an off switch 109, and a changeable battery 107.

As illustrated, the front side 101 of the receiving unit 100 is attached to the back side 102 with a pair of screws 108. One screw 108 is located in the top end 103 and the second screw 108 is located in the bottom end 105. A round recess (not shown) may be formed in the back side 102 to conceal the screws 108 and keep them below the surface so as to not become snagged when removing the receiving unit 100 from a pocket. In another embodiment, only one screw is required at one end and the other end has a tab (not shown) on one side and the tab slips into a recess in the other side allowing the two halves to be held tightly together with one screw rather than two. In still another embodiment, no screws are used to hold the two halves together. The two halves are held firmly together with snaps, but with the application of sufficient force, the two sides may be pulled apart to change the battery or internal repair work.

In the preferred embodiment, the outer surface of the housing will be decorated to make it aesthetically pleasing, such as a Zodiac sign or a favorite animal or cartoon character, or may be imprinted with the logo of a company, such as a cell phone service provider, that may give away the key locator device as a promotional item.

A digital display 110 is located near the top end 103 of the front side 101 of the receiving unit 100 so that the display is visible from the front side 101. The digital display has at least one line of text, but preferably has two or more lines of text with enough digital columns, at least ten, to display the area code and the phone number. There may be more columns to allow for spaces, parentheses, hyphens, or other text characters. The display may be self lighting or back lit so it may be seen in the dark, or a small light (not shown) may be included and if necessary, a push button (not shown) would be used to turn the light or back light feature on and off. The digital display 110 may be a LED display, a liquid crystal display, a plasma type display, a thin film transistor (TFT) array display, or any other suitable display. The display may have a fine enough resolution, such as the TFT displays on new cell phones, that the number of characters is not limited and may be black and white or color. Generally, however, it is preferable that the characters be displayed large enough to be readily legible when standing near the receiver.

The message to be displayed may consist of solely the phone number of cell phone which is programmed with the locator feature, or may include the name of the person, e.g., “Mike” as illustrated, a company name, or simply the message “if found, please call XXX. Programming, and an integrated timing device, within the electrical circuitry 106 can be used to determine characteristics of the display such as a delay from initial activation to message display (to first allow the owner to attempt to locate the lost item using the audible signal), the duration of the display after activation, and possible periodic reactivation after the display duration times out, to preserve battery life. Similarly, the timing function can be used to control initial activation, duration and periodic activation of the audible signal.

The electronic circuitry 106 is enclosed within the body and controls all functions of the receiving unit 100. Selection of appropriate electronic circuitry 106 will apparent to those of skill in the art and will preferably include a single chip receiver module and one or more integrated circuits (ICs) for control of the display and audio functions which will be selected for compactness. The receiver module and control ICs, i.e., electronic circuitry 106, will be mounted on a printed circuit board in electrical communication with the digital display 110, the on/off switch 109, the sound generator 140, the battery 107 and an antenna (not shown).

The electronic circuitry 106 controls activation timing, duration and message generation of the digital display 110, and the type, duration and volume of the sound generated by the sound generator 140. The electronic circuitry 106 also checks the status of the battery 107 and can alert the user by issuing a specific beep or a visual message on the display 110. The electronic circuitry 106 may also perform self diagnosis and alert the owner in a similar manner as with the battery check. In another embodiment, an electronic time out feature may be included in the electronic circuitry to automatically turn on and off the digital display 110 and the sound generator 140.

A pre-programmed code is located within the electronic circuitry 106. When the receiving unit 100 receives an electronic signal from the cell phone network, the receiving unit analyzes the signal, and if that unique signal code matches the pre-programmed code in the receiving unit 100, the unit is activated. The pre-programmed code may be changed either by electrically programming methods or by mechanical thumb switches (not shown).

An on/off switch 109 is attached to the inside of the front side 101 of the receiving unit 101. The on/off switch 109 could be a push button or a slide type on/off switch. The finder of the lost item could turn off the beeping sound. The switch would be able to turn the digital display 110 off separately. In one embodiment, there could be a separate on/off switch for each of the sound and the display.

In another embodiment, the on/off switch 109 may be a mercury contact switch and upon activation of the receiving unit 100, the electronic circuitry could pole the status of the on/off switch 109 to determine whether it is making contact or not, that is whether it is on or off, and then look for a change in that status to turn off the sound and turn on the message on the digital display 110. The change in status would be triggered automatically when the unit is picked up or moved. The mercury contact switch may also automatically activate the lighting feature when the unit is picked up or moved.

One or more batteries 107 are retained within the housing and electrically connected to the electronic circuitry 106, the sound generator 140, and the digital display 110. The batteries are preferably watch- or calculator-type batteries for compactness, but may also be AA or AAA batteries, depending on power needs and size requirements. The batteries may be preferably a lithium type battery, an alkaline type battery, or any commercially-available battery. The batteries are replaced by separating the front side 101 from the back side 102. In one embodiment, a snap on or a screw on cover (not shown) may be located one side of the housing may allow access to change the batteries without having to separate the two halves of the receiving unit 100. In another embodiment, the batteries can be rechargeable and a recharging socket would be accessible from the housing outer surface.

Sound generator 140 is located on the inside side of the back side 102 of the receiving unit 100. Holes or slots 150 may be formed in the back side 102 to permit the sound to be emitted from the receiving unit 100. The sound generator 140 is in electrical connected to the electronic circuitry 106 by wires (not shown). The sound generator 140 may be a piezo electronic sound device, a small speaker, or any other sound generating device.

A key ring 130 is attached to the bottom end 105 via a chain/cable 120. The chain/cable 120 may be made of any durable, flexible material that is commonly used for key chains, such as metal wire, chain or cable, a polymer braid or strand, such as nylon, or leather. An item (not shown), such as a key or a set of keys, is attached to the key ring 130. The key ring 130 is a standard, off-the-shelf split ring or a clasp type ring allowing the keys to be easily removed. The key ring 130 may also be attached to any other item and does not necessarily have to be keys.

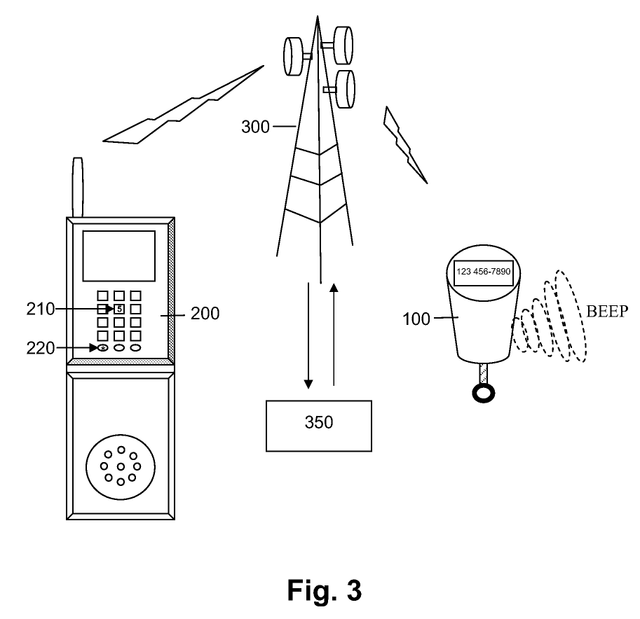

Illustrated in FIG. 3, the cell phone 200 is a standard, commercially available cell phone, but a pre-programmed function algorithm (vertical service code or feature code) has been input into cell phone's electronic circuitry. Pre-programmed codes of this type are well known in the art and are commonly enabled upon purchase of the phone or service contract. The pre-programmed function in the cell phone 200 is activated by pressing a series of key strokes. In the one embodiment, the key stroke that initiates the pre-programmed function is the pressing of the * (star) key 220 followed by the pressing of the number “5” key 210 which is also the k key in most cellular phones. (Use of the “k” for “key” provides a trigger to help the user remember how to activate the function since this feature may not be used as frequently as other functions of the phone.) Alternatively, the code can consist of the star key followed by the keys to spell out “key” or “keys”, which would be “539” or “5397”. Using a longer code will help avoid conflicts with other vertical service codes that are already within a particular cell phone service area.

When the specific key stroke is pressed, the pre-programmed function is initiated to transmit a standard, but unique cell phone signal within a cell phone network. This signal is picked up by the cell phone tower 300 and transmitted to the cell phone network 350. The cell phone network 350 is programmed to respond to the unique signal by transmitting another standard but uniquely encoded signal through cell phone towers within the area surrounding the receiving tower. This reply signal generated by the cell phone network 350 and emitted by the cell phone tower 300 will activate only a receiving unit 100 that has been pre-programmed with that unique signal, much like dialing a particular phone number will activate only the phone programmed with that specific number. The receiving unit 100 will only receive the signal if it is within receiving range of the generating cell phone towers.

The present invention is an improvement upon the prior art systems that had limited ranges or capabilities in terms of how the lost items are found. The inventive system is readily enabled using known technologies and service can be easily established by using conventional feature code (vertical service code) capabilities available from most, if not all, mobile phone service providers. The ease of implementation makes the invention an economical device that can be used by businesses for promotional purposes.

The foregoing description of preferred embodiments is not intended to be limited to the specific details disclosed herein. Rather, the present invention extends to all functionally equivalent structures, methods and uses as fall within the scope of the appended claims.

1. An system for locating an item, the system comprising:
a wireless communications network for providing communication services;
a receiving unit having a receiver module for receiving a unique identifier code transmitted by the wireless communications network, electronic control circuitry in communication with the receiver module, a digital display and a sound generator connected to and controlled by the control circuitry, a battery for providing power to the receiver module, control circuitry, digital display and sound generator, and an attachment means for attaching the receiving unit to the item; and
a mobile phone in communication with the wireless communications network, the mobile phone having a pre-programmed function code that is initiated by a pre-determined series of key strokes, wherein the series of key strokes causes a first signal to be transmitted by the mobile phone for receipt by the wireless communications network and wherein, in response to receipt of the first signal, the wireless communications network transmits an activation signal including the unique identifier code to the receiving unit to activate one or both of the digital display and the sound generator.

2. The system of claim 1, wherein the series of key strokes comprises a star key and a number “5” key in sequence.

3. The system of claim 2, wherein the series of keys strokes further comprises a number “3” key and a number “9” key in sequence after the number “5” key.

4. The system of claim 1, wherein the control circuitry includes a timing function for control one or more of an activation delay and a duration of the digital display.

5. The system of claim 4, wherein the timing function is programmable for activating the sound generator before activating the digital display.

6. The system of claim 1, wherein the control circuitry includes a timing function for control one or more of an activation delay and a duration of the sound generator.

7. The system of claim 1, wherein, upon activation, the digital display displays a message comprising a telephone number of the mobile phone.

8. The system of claim 1, wherein the digital display comprises a thin film transistor or LCD display.

9. A method for locating a misplaced item comprising:
attaching the item to a receiving unit having a receiver module for receiving a unique identifier code transmitted by the wireless communications network, electronic control circuitry in communication with the receiver module, a digital display and a sound generator connected to and controlled by the control circuitry, a battery for providing power to the receiver module, control circuitry, digital display and sound generator, and an attachment means for attaching the receiving unit to the item;
programming a mobile phone with a pre-programmed function code, wherein the pre-programmed function code is coordinated with a wireless communications network to transmit the unique identifier code to the receiving unit when a pre-determined series of keystrokes is entered on the mobile phone;
transmitting the unique identifier code to the receiving unit to activate the receiving unit;
activating the sound generator to generate an audible signal; and
activating a digital display for displaying a message for contacting an owner of the misplaced item.

10. The method claim 9, wherein the series of key strokes comprises a star key and a number “5” key in sequence.

11. The method of claim 10, wherein the series of keys strokes further comprises a number “3” key and a number “9” key in sequence after the number “5” key.

12. The method of claim 9, wherein the control circuitry includes a timing function for control one or more of an activation delay and a duration of the digital display.

13. The method of claim 12, wherein the timing function is programmable for activating the sound generator before activating the digital display.

14. The method of claim 9, wherein the control circuitry includes a timing function for control one or more of an activation delay and a duration of the sound generator.

15. The method of claim 9, wherein, upon activation, the digital display displays a message comprising a telephone number of the mobile phone.

16. An item location system comprising:
a mobile phone having a pre-programmed function, wherein the pre-programmed function is activated by pressing a series of keys on the mobile phone, wherein upon activation of the pre-programmed function, a first electronic signal is transmitted from the mobile phone and transmitted to a wireless communications network; wherein the wireless communications network transmits a second electronic signal; and
a receiving unit physically connected to the item, the receiving unit having a unique activation code, wherein the receiving unit receives the second electronic signal, and, if the second electronic signal matches the unique activation code, the receiving unit is activated to generate an audible signal and a digital display comprising contact information for an owner of the item.

17. The system of claim 16, wherein the series of key strokes comprises a star key and a number “5” key in sequence.

18. The system of claim 16, wherein the receiving unit comprises control circuitry having a timing function for controlling one or more of an activation delay and a duration of the digital display.

19. The system of claim 18, wherein the timing function is programmable for activating the sound generator before activating the digital display.

20. The system of claim 16, wherein, upon activation, the digital display displays a message comprising a telephone number of the mobile phone.
